(19) United States
(12) Patent Application Publication
(10) Pub. No.: US 2009/0003018 A1
(43) Pub. Date: Jan. 1, 2009

(54) DC TO DC CONVERSION CONTROL SYSTEM AND METHOD

(76) Inventors: Barry O. Blair, Garland, TX (US); Rick L. Barnett, Dallas, TX (US); Donald Marabell, Dallas, TX (US); Kalyan Siddabatula, Plano, TX (US)

Correspondence Address: CARR LLP, 670 FOUNDERS SQUARE, 900 JACKSON STREET, DALLAS, TX, 75202, US

(21) Appl. No.: 11/872,270

(22) Filed: Oct. 15, 2007

Related U.S. Application Data
(60) Provisional application No. 60/947,279, filed on Jun. 29, 2007.

(51) Int. Cl. H02M 3/335; H02M 3/00

(52) U.S. Cl. 363/17; 363/15; 363/20

(57) ABSTRACT

A direct current to direct current (DC/DC) converter control systems and related methods are disclosed. An exemplary embodiment provides a control circuit configured to modulate the duty cycles of a first switching device and a second switching device, and is further configured to compensate for a voltage drift at a monitoring node by varying the modulation for at least one of the switching devices.

### CROSS-REFERENCE TO RELATED APPLICATIONS

This application relates to, and claims the benefit of the filing date of, co-pending U.S. provisional patent application Ser. No. 60/947,279 entitled DC TO DC CONVERSION CONTROL SYSTEM AND METHOD, filed Jun. 29, 2007, the entire contents of which are incorporated herein by reference for all purposes.

### TECHNICAL FIELD

The present invention relates in general to power converters and, more specifically, to control of DC/DC power converters.

### BACKGROUND

A common practice in the field of power conversion is to use switching power supplies to convert direct current (DC) voltage of one level to an isolated DC voltage at a second level. A circuit topology that is generally well suited for this purpose is the half bridge converter. In part, half bridge converters are preferred because of their low part count relative to full bridge converters, their compact size, and simplicity.

Half bridge converters can provide reasonably accurate control of the average output current that they generate. However, conventional half bridge converters suffer from several disadvantages. For example, it has previously been impractical to control the current by use of current programmed control in conventional half bridge converters. Capacitors coupled to the transformer primary winding tend to destabilize the current programmed control system.

Soft switching of devices is generally desirable in switching converters. An exemplary zero voltage switching (ZVS) half bridge converter utilizing soft switching is described in Yoshida, Koji et al., “A Novel Zero-Voltage-Switched Half-Bridge Converter With Active Current-Clamped Transformer.” Power Electronics Specialists Conference, 1996. PESC '96 Record., 27th Annual IEEE: 632-637 vol. 1, b. However, this proposal requires operation of the active clamp duty cycle at 50% in order to utilize a common gate drive transformer to drive the gates of the transistors comprising a bi-directional switch. Unfortunately, during operation with current programmed control, the voltage at the node of the converter connecting two capacitors and one side of the output transformer's primary winding can drift. The voltage should remain at approximately the midpoint voltage between the voltage rails. However, the drift, left unchecked can result in the node voltage rising or falling to the level of one of the input rails, thereby rendering the converter inoperative.

Thus, what is needed is a more reliable half bridge converter capable of controlling its average output current.

### SUMMARY OF THE INVENTION

A direct current to direct current (DC/DC) converter and related methods are provided by an embodiment of the present invention. An embodiment of the DC/DC converter comprises a first switching device, a second switching device, and a control circuit configured to modulate a duty cycle of the first switching device and a duty cycle of the second switching device and further configured to compensate for a voltage drift at a monitoring node of the converter by varying at least one of the modulation of the duty cycle of the first switching device and the modulation of the duty cycle of the second switching device.

Embodiments of the control circuit comprise a first controller coupled to the first switching device and to the second switching device, and a second controller coupled to the first controller, to the monitoring node and to a voltage reference. For example, the monitoring node in an embodiment is between capacitors, each connected to an opposing voltage rail, wherein the voltage reference is one of the voltage rails and the second controller monitors voltage at the monitoring node for a drift away from the midpoint voltage between the voltage rails.

In an embodiment, in response to a voltage drift at the monitoring node, the second controller is configured to adjusting an input signal to the first controller, thereby causing the first controller to vary at least one of the modulation of the duty cycle of the first switching device and the modulation of the duty cycle of the second switching device. In some embodiments, the control circuit varies both the modulation of the duty cycle of the first switching device and the modulation of the duty cycle of the second switching device. In some embodiments, the control circuit varies the modulation of the duty cycle of only one of the switching devices, for example by lengthening or shortening the duty cycle based on whether the voltage at the monitoring node is too high or too low. In some embodiments, the DC/DC converter comprises a zero voltage switching (ZVS) half bridge DC/DC converter.

In an embodiment of a method for operating a DC/DC converter, a voltage drift at a monitoring node of the converter is sensed and at least one of a modulation of a duty cycle of a first switching device and a modulation of a duty cycle of a second switching device is varied to compensate for the voltage drift. The exemplary method further comprises modulating the duty cycle of the first switching device and the duty cycle of the second switching device with a first controller and, in response to sensing the voltage drift at the monitoring node, adjusting an input signal to the first controller to vary at least one modulation.

### BRIEF DESCRIPTION OF THE DRAWINGS

For a more complete understanding of the present invention, and the advantages thereof, reference is now made to the following descriptions taken in conjunction with the accompanying drawings, in which:

FIG. 1 is schematic illustrating an embodiment of the present invention.

FIG. 2A is a schematic illustrating a current doubler output circuit for use with the circuitry shown in FIG. 1.

FIG. 2B is a schematic illustrating a center-tap output circuit for use with the circuitry shown in FIG. 1.

FIG. 3 is a timing diagram of the circuit of FIG. 1 when the circuit is balanced.

FIG. 4 is a timing diagram of the circuit of FIG. 1 when the circuit compensates for a high voltage drift at a monitoring node.

FIG. 5 is a timing diagram of the circuit of FIG. 1 when the circuit compensates for a low voltage drift at a monitoring node.

FIG. 6 is another timing diagram of the circuit of FIG. 1 when the circuit compensates for a high voltage drift at a monitoring node.

### DETAILED DESCRIPTION

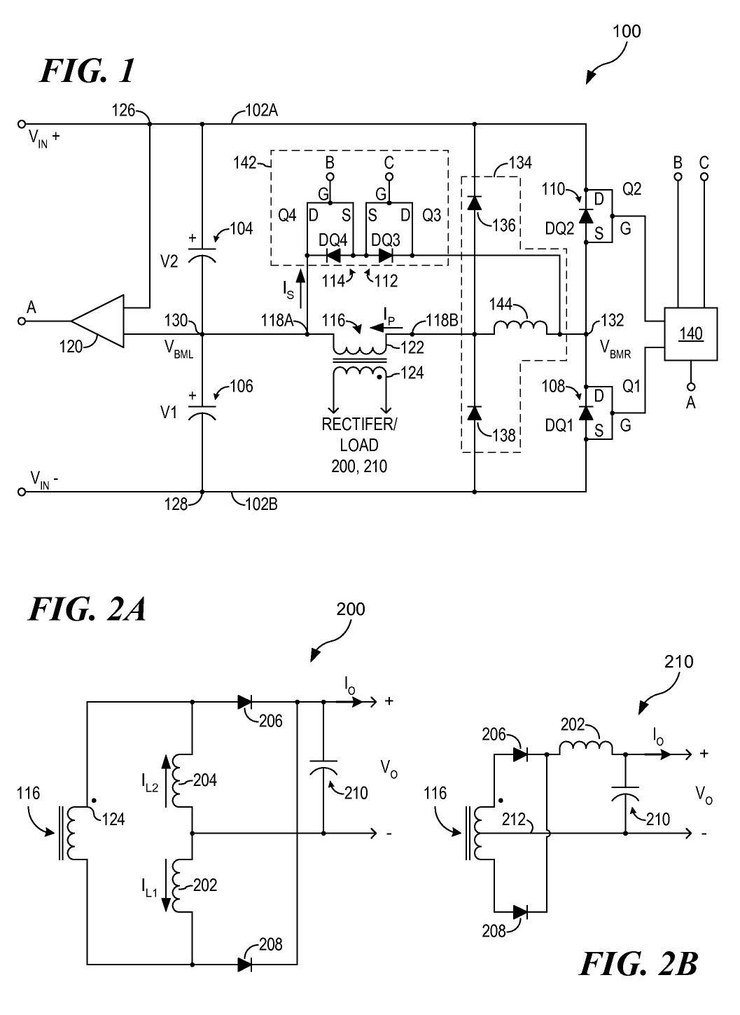

Referring to FIG. 1 of the drawings, the reference numeral 100 generally designates a system embodying features of the present invention. The system 100 includes a pair of DC power input voltage rails 102A and 102B; two capacitors 104 and 106; four switches 108, 110, 112 and 114; a transformer 116; a controller 120; and a controller 140. Together, controller 120 and controller 140 form a control circuit for system 100. Switches 108, 110, 112 and 114 are shown as MOSFET transistors, which comprise semiconductor switching devices, however it should be understood that other types switching devices may also be used.

In the illustrated embodiment, switches 108, 110, 112, and 114 are shown comprising transistors Q1-Q4 with body diode effects, represented as DQ1-DQ4, respectively. Each of switches 108, 110, 112, and 114 has parasitic capacitance that enables zero voltage switching (ZVS) and a control input G (i.e., a gate terminal) coupled to controller 140. As illustrated, switch 114 is coupled through node B to controller 140 and switch 112 is coupled through node C to controller 140. Controller 140 operates transistors Q1-Q4 using pulse width modulation (PWM) to control the duty cycles of switches 108, 110, 112, and 114. Also in the illustrated embodiment, system 100 is shown comprising an optional diode clamp 134, which comprises diodes 136 and 138, and an inductor 144.

Transformer 116, comprising a primary winding 122 and a secondary winding 124, is coupled to switch 114 and inductor 144 at nodes 118A and 118B. As shown in FIG. 1, node 118A is coupled to a monitoring node 130, having a voltage V_{BML}, whereas node 118B is coupled, through optional diode clamp 134, to node 132, having a voltage V_{BMR}. If optional clamp 134 were not included, node 118B would be coupled directly to node 132. Node 132 is between switches 108 and 110, and thus, transformer 116 is coupled between monitoring node 130 and both of switches 108 and 110. Node 130 is between capacitors 104 and 106, which are coupled to voltage rails 102A and 102B, respectively. Secondary winding 124 leads to a rectifier load 200 or 210, as illustrated in FIGS. 2A and 2B, respectively.

FIG. 1 illustrates that the above-described components can be interconnected to form a ZVS half bridge direct current to direct current (DC/DC) converter, as shown in the illustrated embodiment of system 100. More particularly, capacitors 104 and 106 are connected in series between positive and negative voltage rails 102A and 102B. Similarly switches 108 and 110 are also connected in series between positive and negative rails 102A and 102B. Between the series connection between capacitors 104 and 106 and the series connection between switches 108 and 110, transformer 116 is connected in parallel with a bidirectional switch 142 formed by the series connection of switches 112 and 114.

System 100 can also define four nodes 126, 128, 130, and 132 among others. The first of these nodes, a voltage reference node 126, corresponds to the high voltage DC input terminal coupled to voltage rail 102A at voltage V_{IN+}. The second of these nodes, 128, can likewise correspond to the low voltage DC input (V_{IN-} or ground potential) corresponding to voltage rail 102B. Regarding the third node 130 at V_{BML}, it may correspond to the interconnection between the two capacitors 104 and 106 and one side of primary winding 122 of transformer 116. The fourth of these particular nodes, 132, can correspond to the opposing side of primary winding 122 of transformer 116 from node 130, and is at a voltage at V_{BMR}.

With further regard to switches 108, 110, 112 and 114, they are connected as illustrated in FIG. 1. The source, S, of transistor Q1 in switch 108 is connected to negative rail 102B, the drain, D, is connected to node 132, and the gate, G, is coupled to controller 140. The drain, D, of transistor Q2 in switch 110 is connected to positive rail 102A, the source, S, is connected to node 132, and the gate, G, is coupled to controller 140.

Regarding bidirectional switch 142, transistors Q3 and Q4 in switches 112 and 114, respectively, are connected between nodes 118A and 132 in parallel with transformer 116. The sources of transistors Q3 and Q4 are connected as shown with the drains of transistors Q3 and Q4 being connected to nodes 118A and 132. Additionally, the gates of the transistors Q3 and Q4 receive control signals from controller 140.

In the illustrated embodiment, the power that is delivered to rectifier load 200 or 210 flows from positive rail 102A through one of two paths. These paths are (1) the path through capacitor 104, transformer 116, and switch 108; and (2) the path through switch 110, transformer 116 and capacitor 106. The magnetizing current of transformer 116 may be used, via transistors Q3 and Q4, to effect ZVS of transistors Q1 and Q2 in switches 108 and 110, respectively. Power then flows to secondary winding 124 of transformer 116 to rectifier load 200 or 210.

In operation, controller 120 senses the voltage V_{BML} of the illustrated embodiment at node 130 and compares V_{BML} to reference voltage V_{IN+} on node 126 in order to sense whether V_{BML} has drifted away from a desired value. For example, the desired value may be the midpoint, or average, voltage between V_{IN+} and V_{IN-} on voltage rails 102A and 102B, respectively. If V_{IN-} is at ground potential, or zero volts, the desired voltage for node 130 is one-half of V_{IN+}. Some embodiments, however may have voltage rail 102B at a different potential than ground potential or possibly operate with a different desired voltage for node 130. A variation of V_{BML} from the desired voltage for node 130 is a voltage drift. It should be understood, however, that a voltage drift may be defined in other embodiments to include a voltage deviation at a different circuit node.

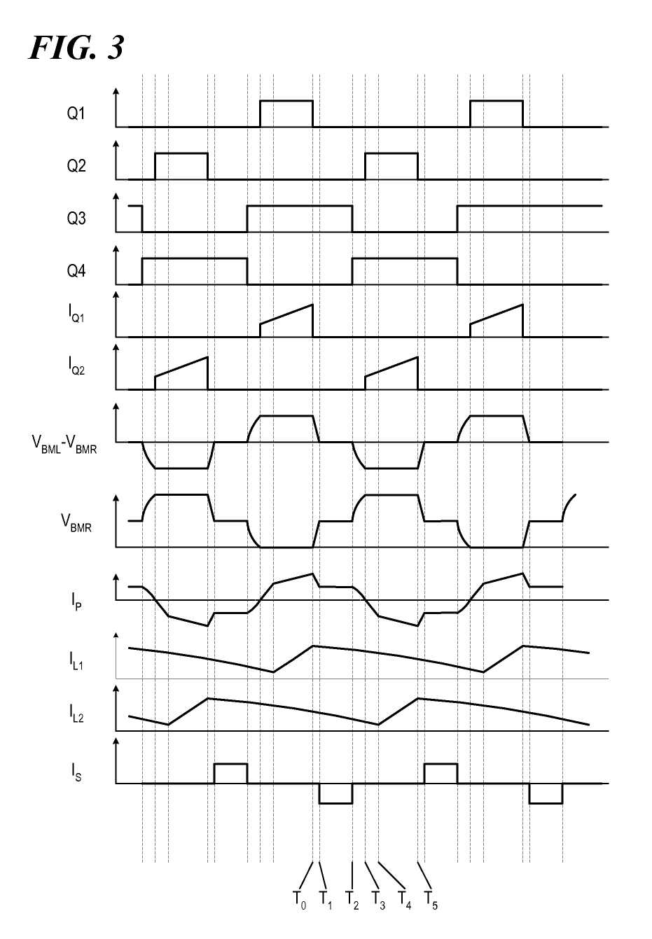

In the illustrated embodiment, controller 120 is coupled to controller 140 through node A and is configured to adjust an input signal to controller 140 in response to a voltage drift sensed at node 130. In normal operation, the voltage at node A acts as a threshold, controlling the current ramp signal in controller 140 to turn off one of transistors Q1 and Q2. By scaling the signal at node A, controller 120 can adjust the time, either advanced or delayed, at which the current ramp signal reaches the threshold. As will be described in further detail, with reference to FIGS. 3-6, by adjusting an input signal to controller 140, controller 120 is able to cause controller 140 to vary the PWM of the duty cycle of at least one of switches 108 and 110 to compensate for a voltage drift. In some embodiments, the modulations of the duty cycles of both switches 108 and 110 are varied. In some embodiments only the modulation of the duty cycle of one of switches 108 and 110 is varied.

Turning now to FIGS. 2A and 2B, rectifier loads 200 and 210 are described. Rectifier load 200 comprises a current doubler output circuit for use with the circuitry shown in FIG. 1 by coupling to secondary winding 124 of transformer 116. Rectifier load 200 is arranged as illustrated in FIG. 2A. Rectifier load 200 comprises inductors 202 and 204, diodes 206 and 208, a capacitor 210, and outputs current Iₒ at voltage Vₒ. Alternatively, rectifier load 210, comprising a center-tap output circuit, may be coupled to secondary winding 124 of transformer 116. Rectifier load 210 is arranged as illustrated in FIG. 2B. Rectifier load 210 comprises inductor 202, diodes 206 and 208, capacitor 210, and outputs current Iₒ at voltage Vₒ. Rectifier load 210 further comprises a center-tap 212 on the secondary winding 124 of transformer 116.

FIG. 3 illustrates signal and timing events in an embodiment of the invention. FIG. 3 illustrates plots, labeled Q1-Q4, which correspond to control signals used to turn transistors Q1-Q4 on to conduct (high signal) or off (low signal). The plots of I_{Q1} and I_{Q2} illustrate the currents flowing through transistors Q1 and Q2, respectively. FIG. 3 also illustrates plots, labeled V_{BML}-V_{BMR} and V_{BML}, which indicate the voltages at nodes 130 and 132. Ideally, V_{BML} is a constant value, thus the plot of V_{BML}-V_{BMR} generally shows an inverted and centered version of the plot of V_{BMR}. The plot of I_{P} illustrates the current flowing through primary winding 122, the plots of I_{L1} and I_{L2} illustrate the currents flowing through inductors 202 and 204, respectively, and the plot of I_{S} illustrates the current flowing through bidirectional switch 142.

With reference now to FIG. 3 and continuing reference to FIGS. 1 and 2B, system 100 can operate as follows in the nominal case when the node 130 voltage V_{BML} is one half of the input voltage V_{IN+}. Just before time T₀, at which time transistor Q1 is switched off, the primary winding 122 current, I_{P}, is flowing through transistor Q1. The voltage across primary winding 122 of transformer 116 is equal to the voltage across capacitor 106. At this time prior to T₀, transistor Q3 is on, but the body diode of the transistor Q4 is reverse biased. Therefore no current flows through the bidirectional switch 142.

Just before time T₀, the current from positive voltage rail 102A is flowing through transistor Q1 (which is on) and transformer 116. However, at time T₀, transistor Q1 is turned off, and the parasitic capacitance of transistor Q1 is charged by the magnetizing current of transformer 116. Thus, the voltage across transistor Q1 begins to increase.

At time T₁ the voltage across transistor Q1 reaches the voltage across capacitor 106. Accordingly, the voltage across body diode DQ4 drops to zero allowing body diode DQ4 to begin conducting. With body diode DQ4 conducting (i.e., the voltage drop across transistor Q4 is negligible), transistor Q4 can be switched on at zero voltage. During the time from T₁ to T₂, primary winding 122 of transformer 116 is short circuited by bidirectional switch 142. Thus, bidirectional switch 142 allows the primary winding 122 current, I_{P}, of transformer 116 to continue flowing.

At time T₂, transistor Q3 is turned off and the magnetizing current of transformer 116 resumes charging the parasitic capacitance of transistor Q1. The resumed charging of this capacitance causes the voltage across transistor Q1 to increase. At time T₃, when the voltage across transistor Q1 has reached the voltage of positive rail 102A, body diode DQ2 of transistor Q2 becomes forward biased and begins conducting. With body diode DQ2 conducting, transistor Q2 can be switched on at zero voltage. This causes current from the positive rail 102A to flow through transistor Q2 and transformer 116. At time T₄, current I_{L2} reverses. At time T₅, transistor Q2 turns off and ceases conducting.

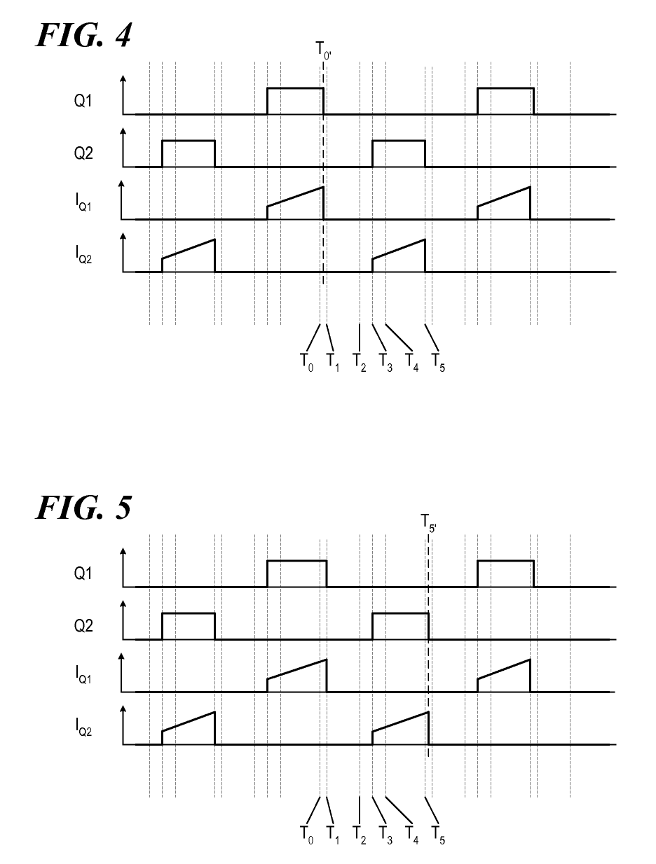

In normal operation, controller 140 operates transistors Q1-Q4 in switches 108, 110, 112 and 114 using PWM of their duty cycles in order to maintain the desired power output for rectifier load 200 or 210. For a higher power output requirement, controller 140 raises the duty cycles, whereas for a lower power output requirement, the duty cycles are lowered. In normal operation, the duty cycles of switches 108 and 110 are balanced and have a constant ratio of approximately one.

Whereas the duty cycles of switches 108 and 104 are modulated by controller 140 to meet power demands on the secondary winding 124 side (load side) of transformer 116, the modulation may varied to an imbalanced condition by controller 120. For example, controller 120 may cause controller 140 to drive switches 108 and 110 to deviate from a balanced duty cycle ratio in order to compensate for a voltage drift on the primary winding (122) side (source side) of transformer 116. For example, by increasing the duty cycle of switch 108 relative to the duty cycle of switch 110 to compensate for a positive voltage drift, the duty cycles of switches 108 and 110 are temporarily imbalanced and the duty cycle ratio is varied. The variation of the modulation can also compensate for a negative voltage drift by increasing the duty cycle of switch 110 relative to the duty cycle of switch 108. The relative change in the duty cycle ratio can be accomplished by one of switches 108 and 110 having its duty cycle increased or decreased, or by having either switch's duty cycle increased, or by having either switch's duty cycle decreased. Exemplary off-nominal cases are depicted in FIGS. 4-6.

In accordance with one embodiment, system 100 operates as follows for off-nominal cases when a voltage drift is sensed by controller 120. As depicted in FIG. 4, for example, if a positive voltage drift is sensed (i.e., V_{BML} at node 130 is above the desired value), controller 120 will cause controller 140 to hold transistor Q1 on for a longer time, turning transistor Q1 off at T₀, rather than at T₀, thereby increasing the duty cycle of switch 108. This variation in the duty cycle of switch 108 is superimposed over the PWM, and comprises a variation in the modulation, creating an imbalance in the ratio of the duty cycles of switches 108 and 110. This compensating imbalance lasts until the voltage drift is no longer sensed.

Because transistor Q1 is held on for a longer time, as depicted in FIG. 4, V_{BML} is partially bled down through transformer 116. Preferably, transistor Q1 is held on by controllers 120 and 140 for a time that is related to the deviation of V_{BML} from the desired level. Thus, V_{BML} can be returned to the desired level, for example one half of V_{IN+}. When the voltage drift is no longer sensed by controller 120, the duty cycle ratio returns to a balanced condition.

Similarly, with reference to FIG. 5, if a negative voltage drift is sensed, (i.e., V_{BML} at node 130 is below the desired value), controller 120 will delay the time at which the input signal on node A reaches the threshold, causing controller 140 to hold transistor Q2 on for a longer time. This causes transistor Q2 to turn off at T₅, rather than at T₅, thus increasing the duty cycle of switch 110. This variation in the duty cycle of switch 110 is superimposed over the PWM, and comprises a variation in the modulation, creating an imbalance in the ratio of the duty cycles of switches 108 and 110. This imbalance lasts until the voltage drift is no longer sensed.

Because transistor Q2 is held on for a longer time, as depicted in FIG. 5, V_{BML} is pulled up through transformer 116. Preferably, transistor Q2 is held on by controllers 120 and 140 for a time that is related to deviation of V_{BML} from the desired level. Thus, V_{BML} can be returned to the desired level, for example one half of V_{IN+}. When the voltage drift is no longer sensed by controller 120, the duty cycle ratio returns to a balanced condition.

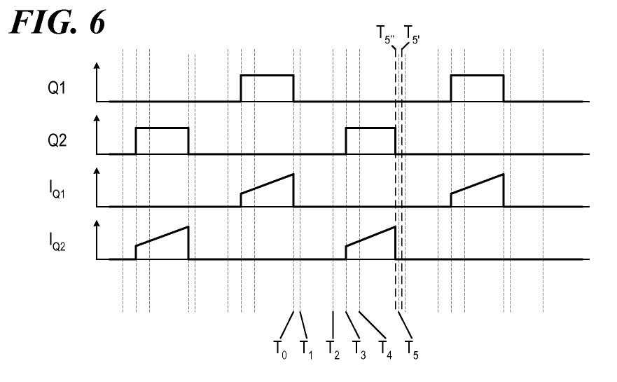

As an alternative to varying the control pulse widths to both transistors Q1 and Q2, controllers 120 and 140 can vary the control pulse width to just one of transistors Q1 and Q2. This approach is depicted by contrasting FIG. 6 with FIGS. 4 and 5. For example, if the duty cycle of switch 110 alone is varied, controllers 120 and 140 can operate as previously described in FIG. 5 during a low node 130 voltage (V_{BML}) scenario. However, for a high node 130 voltage scenario (positive voltage drift) controllers 120 and 140 can shorten the pulse width which holds transistor Q2 on, rather than lengthen the pulse width which holds transistor Q1 on. As depicted in FIG. 6, if controller 120 advances the time at which the input signal at node A reaches the threshold, transistor Q2 is turned off at T₅, rather than at T₅, thus decreasing the duty cycle of switch 110. Less current flows through transistor Q2, thereby causing V_{BML} to drop and system 100 to return to a balanced condition.

Having thus described the present invention by reference to certain of its preferred embodiments, it is noted that the embodiments disclosed are illustrative rather than limiting in nature and that a wide range of variations, modifications, changes, and substitutions are contemplated in the foregoing disclosure and, in some instances, some features of the present invention may be employed without a corresponding use of the other features. Many such variations and modifications may be considered obvious and desirable by those skilled in the art based upon a review of the foregoing description of preferred embodiments. Accordingly, it is appropriate that the appended claims be construed broadly and in a manner consistent with the scope of the invention.

1. A direct current to direct current (DC/DC) converter comprising:
a first switching device;
a second switching device; and
a control circuit configured to modulate a duty cycle of the first switching device and a duty cycle of the second switching device, and further configured to compensate for a voltage drift at a monitoring node of the converter by varying at least one of the modulation of the duty cycle of the first switching device and the modulation of the duty cycle of the second switching device.

2. The converter of claim 1 wherein the control circuit comprises:
a first controller coupled to the first switching device and to the second switching device; and
a second controller coupled to the first controller, to the monitoring node and to a voltage reference.

3. The converter of claim 2 wherein the second controller is configured to cause the first controller to vary at least one of the modulation of the duty cycle of the first switching device and the modulation of the duty cycle of the second switching device.

4. The converter of claim 2 wherein the second controller is configured to adjust an input signal to the first controller in response to the voltage drift at the monitoring node.

5. The converter of claim 2 wherein the first controller is configured to switch the first switching device off upon an input signal reaching a threshold, and the second controller is configured to adjust a time at which the input signal reaches the threshold.

6. The converter of claim 5 wherein the second controller is configured to adjust the time at which the input signal reaches the threshold in response to the voltage drift at the monitoring node, thereby varying the modulation of the duty cycle of the first switching device to compensate for the voltage drift.

7. The converter of claim 1 wherein the control circuit is configured to vary both the modulation of the duty cycle of the first switching device and the modulation of the duty cycle of the second switching device.

8. The converter of claim 1 wherein the control circuit is configured to increase or decrease the duty cycle of the first switching device to compensate for the voltage drift at the monitoring node.

9. The converter of claim 1 further comprising:
a first capacitance coupled between the monitoring node and a first voltage rail;
a second capacitance coupled between the monitoring node and a second voltage rail; and
a transformer coupled between the monitoring node and both the first switching device and the second switching device, wherein the monitoring node is on the primary side of the transformer.

10. The converter of claim 1 wherein the DC/DC converter comprises a zero voltage switching (ZVS) half bridge DC/DC converter.

11. A method of controlling a direct current to direct current (DC/DC) converter, the method comprising:
sensing a voltage drift at a monitoring node of the converter; and
varying a modulation of at least one of a duty cycle of a first switching device and a modulation of a duty cycle of a second switching device to compensate for the voltage drift.

12. The method of claim 11 further comprising:
modulating the duty cycle of the first switching device and the duty cycle of the second switching device with a first controller; and
adjusting an input signal to the first controller in response to sensing the voltage drift at the monitoring node.

13. The method of claim 12 wherein adjusting an input signal comprises adjusting a time at which the input signal reaches a threshold.

14. The method of claim 12 wherein modulating the duty cycle of the first switching device comprises switching the first switching device off upon an input signal reaching a threshold.

15. The method of claim 11 wherein varying at least one of the modulation of the duty cycle of the first switching device and the modulation of the duty cycle of the second switching device comprises varying both the modulation of the duty cycle of the first switching device and the modulation of the duty cycle of the second switching device.

16. The method of claim 11 wherein varying at least one of the modulation of the duty cycle of the first switching device and the modulation of the duty cycle of the second switching device comprises increasing or decreasing the duty cycle of the first switching device.

17. The method of claim 11 wherein sensing a voltage drift comprises sensing a voltage drift in a zero voltage switching (ZVS) half bridge DC/DC converter.

18. A direct current to direct current (DC/DC) converter means comprising:
means for modulating a duty cycle of a first switching means; and
means for varying the modulation to compensate for a voltage drift at a monitoring node of the converter means.

19. The means of claim 18 wherein the means for modulating a duty cycle of a first switching means further comprises means for modulating a duty cycle of a second switching means, and wherein the means for varying the modulation comprises means for varying the modulation of both the first switching means and the second switching means.

20. The means of claim 18 wherein the means for varying the modulation further comprises means for sensing the voltage drift.
